(19) United States
(12) Patent Application Publication
(10) Pub. No.: US 2026/0058413 A1
(43) Pub. Date: Feb. 26, 2026

(54) CONNECTOR

(71) Applicant: LS MTRON LTD., Anyang-si, Gyeonggi-do (KR)

(72) Inventors: Jung Hoon CHOI, Anyang-si, Gyeonggi-do (KR); Kyung Hae CHOI, Anyang-si, Gyeonggi-do (KR); Hyun Woo LEE, Anyang-si, Gyeonggi-do (KR)

(21) Appl. No.: 19/102,621

(22) PCT Filed: Aug. 1, 2023
(86) PCT No.: PCT/KR2023/011254

§ 371 Date: Feb. 10, 2025

(30) Foreign Application Priority Data
Sep. 30, 2022 (KR) 10-2022-0125238
Jun. 9, 2023 (KR) 10-2023-0074209

(51) Int. Cl. H01R 13/6581; H01R 12/70; H01R 12/71; H01R 13/115; H01R 13/504

(52) U.S. Cl. CPC H01R 13/6581; H01R 12/707; H01R 12/712; H01R 13/115; H01R 13/504

(57) ABSTRACT

A connector comprising a plug connector and a receptacle connector coupled and electrically connected to the plug connector is disclosed. The plug connector comprises: a plug insulator having a length in a first direction and a width in a second direction perpendicular to the first direction; a plurality of plug contacts coupled to the plug insulator and arranged to be spaced apart from each other along the first direction; and a plug shield which covers an edge of the plug insulator and is coupled to the plug insulator. The plug shield comprises a pair of first plug shield sidewalls forming side surfaces in the first direction, and a pair of second plug shield sidewalls forming side surfaces in the second direction, wherein at least a portion of the second plug shield sidewalls may be formed to have a lower height than the first plug shield sidewalls.

### CROSS-REFERENCE TO RELATED APPLICATIONS

This application is a National Stage of International Application No. PCT/KR2023/011254, filed Aug. 1, 2023, which claims priority to and the benefit of Korean Patent Application No. 10-2022-0125238, filed Sep. 30, 2022, and Korean Patent Application No. 10-2023-0074209, filed Jun. 9, 2023, the disclosures of which are incorporated herein by reference in its entirety.

### FIELD

The present disclosure relates to a connector, and more particularly, to a connector having a structure capable of being miniaturized, maintaining the reliability of energization, and preventing damage due to external force at the same time.

### BACKGROUND

In recent years, circuit boards and connectors for energizably connecting them to other members are also becoming smaller according to the trend of miniaturization of electronic devices. On the other hand, as the amount of information processed by electronic devices is increasing, the number of terminals provided on circuit boards or connectors is also increasing. Accordingly, there is an increasing demand for miniaturized connectors.

An example of the connector may be a B2B connector (board to board connector). The B2B connector is formed to have a thin thickness to electrically connect module substrates for a camera module, a mobile phone liquid crystal module or the like. With the trend of miniaturization of portable electronic devices, the demand for B2B connectors is also increasing.

The B2B connector includes a plug and a receptacle. Each of the plugs and receptacles includes a plurality of terminals (contacts) spaced apart from each other in the longitudinal direction. Terminals respectively provided in the plug and the receptacle may be in contact with each other to form an energization state between modules including the B2B connector.

The plug connector and the receptacle connector are physically coupled to electrically connect the contacts of the plug connector to the contacts of the receptacle connector, and there is a risk that the receptacle connector or plug connector is damaged by pressure during this coupling process. Therefore, there is a need for a method to facilitate coupling between the receptacle connector and the plug connector and improve its strength.

In addition, generally, an RF connector and a board-to-board connector (hereinafter, referred to as a “board connector”) are provided in a wireless communication device such as a smartphone, a tablet PC, and the like among electronic devices. The RF connector is to transmit a radio frequency (RF) signal. The board connector is to process digital signals from cameras and the like. The RF connector and the board connector are mounted on a printed circuit board (PCB). Conventionally, since a number of board connectors and RF connectors are mounted along with a number of components in a limited PCB space, there was a problem in that the PCB mounting area is increased. Therefore, in accordance with the miniaturization trend of smartphones, a technology for optimizing a PCB mounting area into a small area by integrating an RF connector and a board connector is required.

### SUMMARY

The present disclosure is intended to solve the above problems, and the present disclosure is directed to providing a connector capable of being easily coupled and reducing the possibility of damage due to interference during coupling.

In addition, the present disclosure is directed to providing a connector capable of transmitting RF (radio frequency) signals and digital signals at the same time.

In addition, the present disclosure aims to more effectively shield electromagnetic wave noise.

In addition, the present disclosure is directed to providing a structure that may facilitate energization inspection.

The problems of the present disclosure are not limited to those mentioned above, and other problems not mentioned will be clearly understood by those of ordinary skill in the art from the following description.

According to one aspect of the present disclosure, provided is a connector, comprising a plug connector and a receptacle connector coupled to and electrically connected to the plug connector, wherein the plug connector includes a plug insulator having a length in a first direction and a width in a second direction orthogonal to the first direction; a plurality of plug contacts (260) coupled to the plug insulator and disposed to be spaced apart from each other along the first direction; and a plug shield coupled to the plug insulator while covering an edge of the plug insulator, wherein the plug shield includes a first plug shield sidewall and a second plug shield sidewall forming a side surface in the first direction; and a third plug shield sidewall and a fourth plug shield sidewall forming a side surface in the second direction, wherein at least a portion of the third plug shield sidewall and the fourth plug shield sidewall is lower in height than the first plug shield sidewall or the second plug shield sidewall.

According to the above configuration, the connector according to one aspect of the present disclosure can prevent the receptacle socket from being damaged by preventing the plug shield from contacting the receptacle socket when the plug connector and the receptacle connector are coupled by forming a recessed portion on the outer surface of the plug shield.

In addition, the connector according to one aspect of the present disclosure can maintain contact reliability for a long time by having a double contact point structure of contact pins.

In addition, the connector according to one aspect of the present disclosure has a probe contact part formed on the plug connector, so that it can be easily inspected by securing a space to contact the probe during the energization inspection.

In addition, it is possible to implement functions of shielding signals, electromagnetic waves, or the like for RF contacts using receptacle shields, plug shields, and ground contacts. Accordingly, the present disclosure can prevent electromagnetic waves generated from RF contacts from interfering with signals of circuit components located around an electronic device, and prevent electromagnetic waves generated from circuit components located around an electronic device from interfering with RF signals transmitted by RF contacts. Therefore, the present disclosure can contribute to improving EMI (Electro Magnetic Interference) shielding performance and EMC (Electro Magnetic Compatibility) performance using the shield part and the ground contact. Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

FIG. 1 is a perspective view illustrating a connector according to an exemplary embodiment of the present disclosure.

FIG. 2 is a plan view illustrating a receptacle connector and a plug connector of a connector according to an exemplary embodiment of the present disclosure.

FIG. 3 is an exploded perspective view illustrating a receptacle connector of a connector according to an exemplary embodiment of the present disclosure.

FIG. 4 is an exploded perspective view illustrating a plug connector of a connector according to an exemplary embodiment of the present disclosure.

FIG. 5 is a cross-sectional view illustrating a state in which a receptacle connector and a plug connector of a connector are coupled according to an exemplary embodiment of the present disclosure.

FIG. 6 is a perspective view illustrating a receptacle signal contact of a receptacle connector of a connector according to an exemplary embodiment of the present disclosure.

FIG. 7 is a perspective view illustrating an RF receptacle RF contact of a receptacle connector of a connector according to an exemplary embodiment of the present disclosure.

FIG. 8 is a perspective view illustrating a receptacle ground contact of a receptacle connector of a connector according to an exemplary embodiment of the present disclosure.

FIG. 9 is a perspective view illustrating a plug signal contact of a plug connector of a connector according to an exemplary embodiment of the present disclosure.

FIG. 10 is a perspective view illustrating a plug RF contact of a plug connector of a connector according to an exemplary embodiment of the present disclosure.

FIG. 11 is a perspective view illustrating a plug ground contact of a plug connector of a connector according to an exemplary embodiment of the present disclosure.

FIG. 12 is a cross-sectional view illustrating a state in which a plug signal contact and a receptacle signal contact of a connector are coupled according to an exemplary embodiment of the present disclosure.

FIG. 13 is a cross-sectional view illustrating a state in which a plug RF contact and an RF receptacle RF contact of a connector are coupled according to an exemplary embodiment of the present disclosure.

FIG. 14 is a cross-sectional view illustrating a state in which a plug ground contact and an RF ground pin of a connector are coupled according to an exemplary embodiment of the present disclosure.

### DETAILED DESCRIPTION

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. In the drawings, parts unrelated to the description are omitted for clarity of description of the present disclosure, and throughout the specification, same or similar reference numerals denote same elements.

In the following description, in order to clarify the features of the present disclosure, descriptions of some components may be omitted.

The terms “above or upper side”, “below or lower side”, “left side”, “right side”, “front side”, and “rear side” used in the following description will be understood with reference to the coordinate system shown throughout the accompanying drawings.

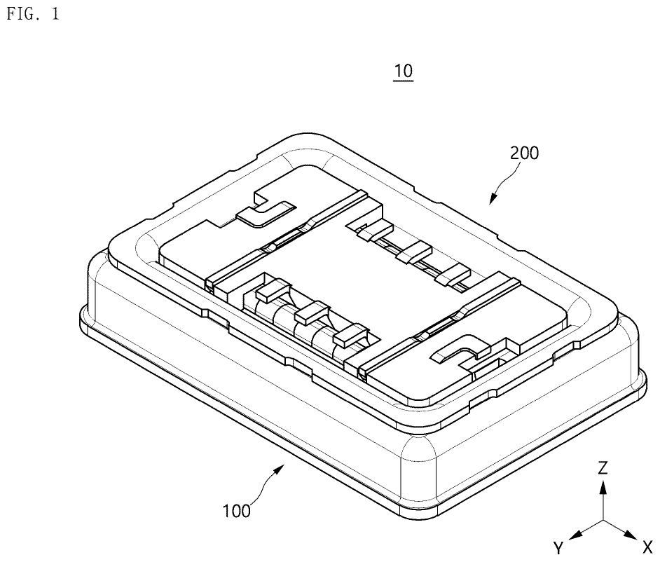

Referring to FIGS. 1 to 4, a connector 10 according to an exemplary embodiment of the present disclosure is shown.

The connector 10 according to the illustrated embodiment includes a plug connector 200 and a receptacle connector 100.

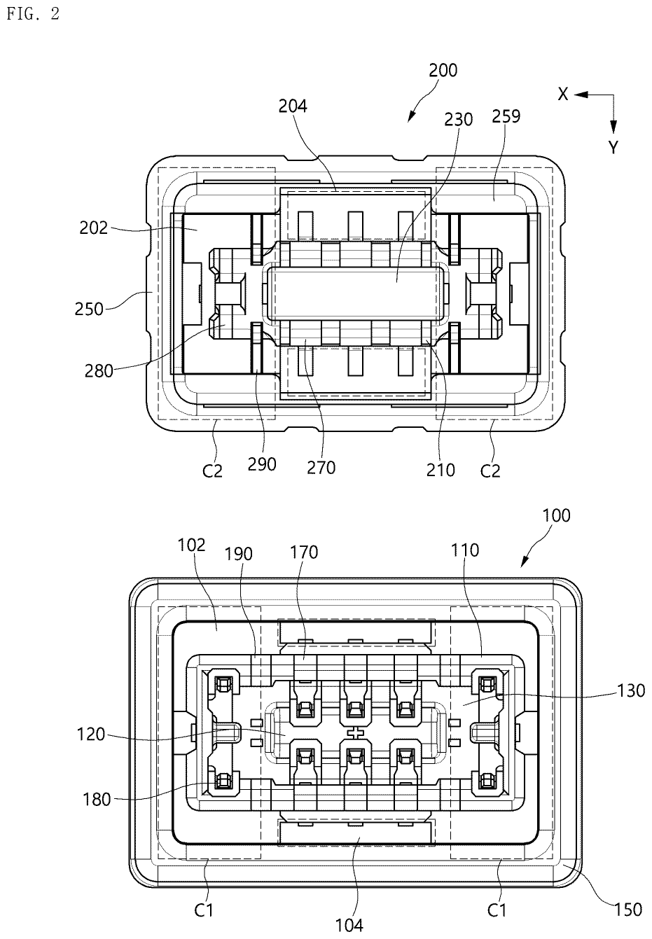

FIG. 1 is a perspective view illustrating a state in which the plug connector 200 and the receptacle connector 100 of the connector 10 according to an exemplary embodiment of the present disclosure are coupled, and FIG. 2 is a plan view illustrating an unfolded state in which the plug connector 200 and the receptacle connector 100 of the connector 10 according to an embodiment of the present disclosure are separated.

The plug connector 200 may be coupled to any one module substrate (not shown). In addition, the receptacle connector 100 may be coupled to another module substrate (not shown). The plug connector 200 and the receptacle connector 100 may be coupled and electrically connected to each other. Accordingly, the one module substrate (not shown) and the another module substrate (not shown) may be electrically connected.

It is assumed that the connector 10 according to an exemplary embodiment of the present disclosure described below is a B2B connector 10. However, it will be understood that the technical features of the plug connector 200 and the receptacle connector 100 provided in the connector 10 according to an exemplary embodiment of the present disclosure, which will be described below, can also be applied to any type of connector 10 including a plurality of plug contacts 260 or a plurality of receptacle contacts 160.

The plug connector 200 and the receptacle connector 100 may be coupled to each other along the height direction, that is, along the Z-axis direction in the illustrated embodiment. By the above coupling, the plug connector 200 and the receptacle connector 100 may be electrically in contact with each other.

The plug connector 200 and the receptacle connector 100 may be formed in shapes corresponding to each other. In the illustrated embodiment, the plug connector 200 and the receptacle connector 100 are provided in a plate shape having a length in the X-axis direction, a width in the Y-axis direction, and a height in the Z-axis direction, respectively.

As shown in FIGS. 1 and 2, the plug connector 200 may be inserted into and fixed to the receptacle connector 100, and a plurality of receptacle contacts 160 disposed in the receptacle connector 100 may form a contact with the plug contacts 260. That is, the receptacle connector 100 and the plug connector 200 may be electrically connected to form a contact, and the receptacle connector 100 may transmit and receive data signals or power through the connected contact. Here, the receptacle connector 100 and the plug connector 200 may be a board to board (B2B) connector 10 that connects boards to each other, and depending on the embodiment, it may support both radio frequency (RF) signals and digital signals at the same time.

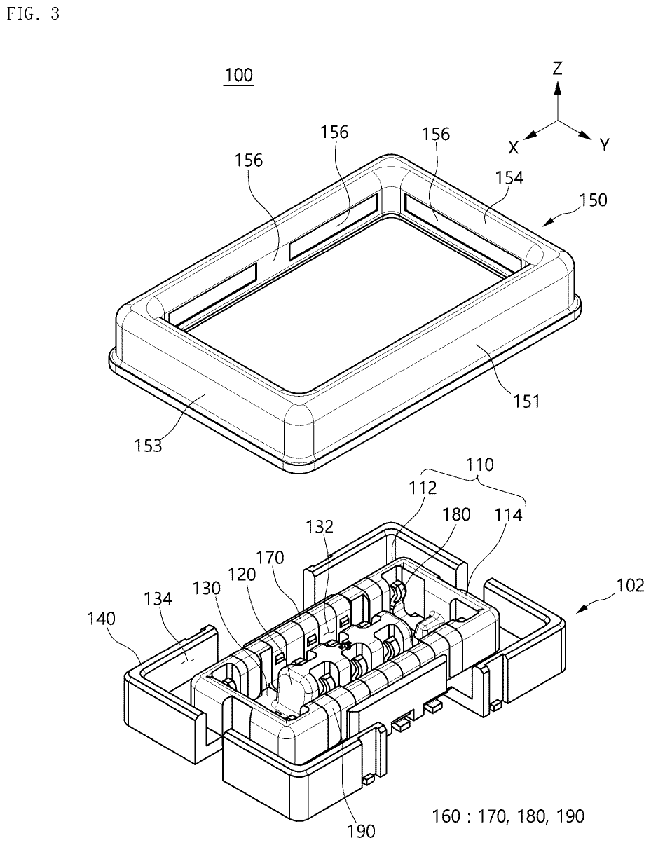

FIG. 3 is an exploded perspective view showing a receptacle connector 100 according to an exemplary embodiment of the present disclosure, and FIG. 4 is an exploded perspective view showing a connector member 200 according to an exemplary embodiment of the present disclosure.

Referring to FIGS. 3 and 4, the receptacle connector 10 according to an exemplary embodiment of the present disclosure may include a receptacle insulator 102, a receptacle contact, and a receptacle shield 150 (hold-down).

As shown in FIGS. 3 and 4, a receptacle contact pin 160 may be disposed in the receptacle insulator 102, and the receptacle shield 150 may be assembled on an edge of the receptacle insulator 102 to form a receptacle connector 100. Here, the receptacle insulator 102 may be formed of an insulating material such as plastic that does not conduct electricity.

The receptacle insulator 102 may have a receptacle socket 110 including a pair of first receptacle socket walls 112 disposed along the X direction, spaced apart from each other in the Y direction, and a pair of second receptacle socket walls 114 disposed to be spaced apart from each other in the X direction.

In this case, the first receptacle socket wall 112 and the second receptacle socket wall 114 are arranged to be connected to each other continuously, and an internal space surrounded by the first receptacle socket wall 112 and the second receptacle socket wall 114 may be formed inside the receptacle socket 110.

In addition, the receptacle insulator 102 may include a receptacle island 120 raised from the inside surrounded by the first receptacle socket wall 112 and the second receptacle socket wall 114 of the receptacle socket 110.

The receptacle island 120 may have the same length direction and width direction as the receptacle insulator 102.

In addition, the receptacle socket 110 and the receptacle island 120 may be formed to protrude from a receptacle base 130 forming the bottom surface of the receptacle insulator 102.

In addition, a space surrounded by the receptacle socket 110, the receptacle island 120, and the receptacle base 130 may accommodate a part of the plug connector 200 to form a first plug accommodation space 132 in which the plug connector 200 and the receptacle connector 100 make electrical contact.

In the first plug accommodation space 132, a portion facing the receptacle base 130 may be opened to accommodate or remove a portion of the plug connector 200 through the opened portion.

In addition, a receptacle shield support part 140 for coupling to the receptacle shield 150 may be formed outside the receptacle socket 110.

The receptacle shield support part 140 is coupled to the receptacle shield 150. The receptacle shield support part 140 constitutes a part of the receptacle insulator 102.

As an example, the receptacle shield support part 140 may be disposed outside the receptacle socket 110 to be spaced apart at a predetermined interval.

In the present embodiment, the receptacle shield support part 140 may be formed to extend from each corner part of the receptacle socket 110.

That is, the receptacle base 130 at the corner where the X and Y directions of the receptacle socket 110 cross each other extends outward, and the receptacle shield support part 140 is formed to protrude from the receptacle socket 110 at a position where the receptacle base 130 extends outward.

In this case, the receptacle shield support part 140 at each corner may be formed continuously with each other, or may be formed separately so as not to be continuously connected. In the present embodiment, it is described as an example that the receptacle shield support part 140 is formed at each corner of the receptacle socket 110 to be spaced apart from each other.

As described above, the receptacle shield support part 140 may be coupled to the receptacle shield 150. In addition, the receptacle shield 150 coupled to the receptacle shield support part 140 and the receptacle socket 110 may form a second plug accommodation space 134 in which the plug connector 200 and the receptacle connector 100 are coupled by inserting a part of the plug connector 200.

In the second plug accommodation space 134, a portion facing a portion where the receptacle base 130 extends may be opened to accommodate a portion of the plug connector 200 through the opened portion to couple or remove the portion.

The receptacle shield 150 may be coupled to the receptacle insulator 102 to reinforce the rigidity of the receptacle insulator 102. In addition, the receptacle shield 150 is configured to be coupled to a module substrate (not shown) while being coupled to the receptacle insulator 102 to increase the coupling force between the receptacle connector 100 and the module substrate (not shown).

In addition, the receptacle shield 150 may be electrically conducted by contacting a part of the plug connector 200. A current having a greater intensity than the current applied to the receptacle contact 160 may be applied to the receptacle shield 150.

To this end, the receptacle shield 150 may be formed of a metal material capable of conducting electricity and having higher rigidity than the receptacle insulator 102.

The receptacle shield 150 may be formed by bending according to the shape of the receptacle insulator 102, and as shown in FIG. 3, it may be integrally formed along the shape of the receptacle shield support part 140 of the receptacle insulator 102 to cover it. The receptacle shield part may be formed by a deep drawing method, a die casting, a metal injection molding (MIM) method, a computer numerical control (CNC) machining, a machining center tool (MCT) machining, or bending and molding a plate material. The receptacle shield 150 may integrally cover the entire inner surface, outer surface, and upper surface of the receptacle shield support part 140 without a joint or a disconnected area.

The receptacle shield 150 may be made of a metal material such as copper (Cu) or an alloy including the same, and may perform a function of guiding the plug connector 200 when coupled to the plug connector 200. That is, since the receptacle shield 150 is formed through a deep drawing method, the corners of the inner surface or outer surface of the receptacle shield 150 may be inclined gently. Therefore, when the plug connector 200 is coupled, the plug connector 200 may be naturally guided on the surface of the receptacle shield 150.

In addition, since the receptacle insulator 102 is made of a material of relatively weak strength such as plastic, there is a risk of damage due to impact applied when the plug connector 200 is coupled, and to prevent such damage, a metal receptacle shield 150 may be assembled to surround an edge of the receptacle insulator 102.

The side surface of the receptacle shield 150 may include a first receptacle shield sidewall 151 and a second receptacle shield sidewall 152 that extend in the X direction, a third receptacle shield sidewall 153 and a fourth receptacle shield sidewall 154 that extend in the Y direction. The first receptacle shield sidewall 151 and the second receptacle shield sidewall 152 may be spaced apart from each other in the Y direction and formed parallel to each other, and the third receptacle shield sidewall 153 and the fourth receptacle shield sidewall 154 may be spaced apart from each other in the X direction and formed parallel to each other. Therefore, the receptacle shield 150 may be coupled to the receptacle shield support part 140 to surround the receptacle insulator 102 while being spaced apart from the receptacle socket 110.

In this case, a second plug accommodation space 134 into which a part of the plug connector 200 is inserted may be formed between the receptacle shield 150 and the receptacle socket 110.

That is, by protecting the receptacle insulator 102 using the metal-based high-strength receptacle shield 150, it is possible to prevent damage to the receptacle insulator 102 and reinforce the strength of the receptacle connector 100.

In addition, since the receptacle shield 150 integrally surrounds the outer edge of the receptacle connector 100 without a disconnected area, it may efficiently shield electromagnetic waves or the like generated from the receptacle contact. When mounted on a PCB substrate or the like, the receptacle shield 150 may be mounted on a pattern of the PCB substrate by soldering or the like to be grounded.

It is important how much RF signal transmission transmitted by the receptacle connector 100 prevents communication quality from deteriorating, such as signal loss, unlike general signals. EMI shielding is important because leaking RF signals can cause malfunctions between electronic devices'chips, and it is important to shield RF signals from leaking to the outside because external noise entering RF contact causes signal loss and signal error. Furthermore, the greater the area in contact with the counterpart plug shield 250 to which the receptacle shield 150 is coupled, the better the RF signal shielding performance, so it is important to secure a contact area between the receptacle shield 150 and the plug shield 250 and ground them.

Meanwhile, the receptacle contact pin 160 is disposed in plurality, and the plurality of receptacle contact pins 160 may be placed on the receptacle socket 110 of the receptacle insulator 102 and the receptacle island 120.

That is, the receptacle contact 160 is disposed to be exposed in the first plug accommodation space 132 and the second plug accommodation space 134 of the receptacle insulator 102.

The receptacle contact 160 may be disposed from the inner surface of the receptacle socket 110 of the receptacle insulator 102 to the side surface of the receptacle island 120.

As shown in FIG. 3, a plurality of receptacle contacts 160 may be arranged at a constant pitch in the receptacle insulator 102, and they may form an electrical contact with the plug connector 200 when the plug connector 200 is inserted. Here, the receptacle contact pins 160 may be placed in an insert molding manner within the receptacle insulator 102.

The receptacle contact pins 160 may be made of a conductive material and may be provided for electrical contact with the plug connector 200 or the substrate.

Some areas of the receptacle contact pin 160 may be exposed from the receptacle insulator 102 for contact with the substrate, and other areas of the receptacle contact pin 160 may be exposed from the receptacle insulator 102 for electrical contact with the plug connector 200.

A plurality of the receptacle contact pins 160 may be disposed in the first plug accommodation space 132 to be spaced apart from each other in the X direction of the receptacle socket 110 so as to be symmetrical to both sides with the receptacle island 120 interposed therebetween.

The receptacle contact pin 160 may include a receptacle signal contact 170, a receptacle RF contact 180, and a receptacle ground contact 190.

A plurality of the receptacle signal contacts 170 may be disposed on both sides of the receptacle socket 110 in the Y direction spaced apart at regular intervals.

As shown in FIGS. 3, 6, and 12, the receptacle signal contact 170 may include a receptacle signal fixing part 172 partially embedded and fixed in the receptacle socket 110, a receptacle signal elastic part 174 formed to be bent from the receptacle signal fixing part 172 along the surface of the receptacle socket 110 in the first plug accommodation space 132, and a receptacle signal contact part 176 bent to protrude toward the first plug accommodation space 132 at the end of the receptacle signal elastic part 174.

The receptacle signal elastic part 174 may be exposed to the surface of the receptacle insulator 102, and may be bent along the shape of the inner surface of the receptacle socket 110 toward the first plug accommodation space 132, and the shape of the surface of the plug base 230. In addition, the receptacle signal elastic part 174 may be bent and extended again upward from a portion formed along the surface of the plug base 230. In this case, the portion bent and extended upward is formed to be spaced apart from the side surface of the receptacle island 120 by a predetermined distance to secure a space for elastic deformation. The receptacle signal contact part 176 is formed at an end of the receptacle signal elastic part 174, and the receptacle signal contact part 176 may electrically contact the terminals of the plug connector 200.

In this case, a pressing protrusion 178 protruding toward the receptacle signal contact part 176 may be formed on the surface of the receptacle signal elastic part 174 facing the receptacle signal contact part 176.

As the pressing protrusion 178 is formed, a terminal introduced between the receptacle signal contact part 176 and the receptacle signal elastic part 174 may contact the receptacle signal contact part 176 with a stronger force.

In addition, a receptacle signal mounting part 178 may be formed to extend from the receptacle signal fixing part 172. The receptacle signal mounting part 178 may penetrate the receptacle insulator 102 and extend to a lower side in the Z direction and an outer side in the Y direction of the receptacle insulator 102 to be exposed. The receptacle signal mounting part may be mounted by a substrate module (not shown), soldering and the like.

Meanwhile, the receptacle RF contact 180 may be disposed at both ends in the X direction of the first plug accommodation space 132.

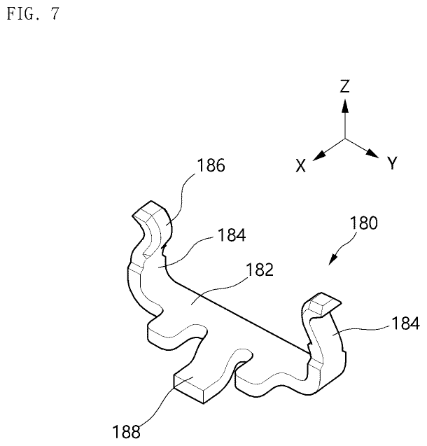

As shown in FIGS. 3, 7, and 13, the receptacle RF contact 180 may include a receptacle RF base member 182 placed in the width direction on the receptacle socket 110 or receptacle base 130, a receptacle RF elastic part 184 that is bent and extended upward from both ends of the receptacle RF base member 182, and a receptacle RF contact part 186 bent so that the end of the receptacle RF elastic part 184 protrudes toward the central portion of the receptacle RF base member 182, and thus may be in double contact with the terminal of the plug connector 100 coupled to the receptacle RF contact 180 to improve reliability of signal transmission.

In addition, a receptacle RF fixing part 188 that is inserted into or embedded and fixed in the receptacle base 130 may be formed to protrude from the base member of the receptacle RF contact part 186.

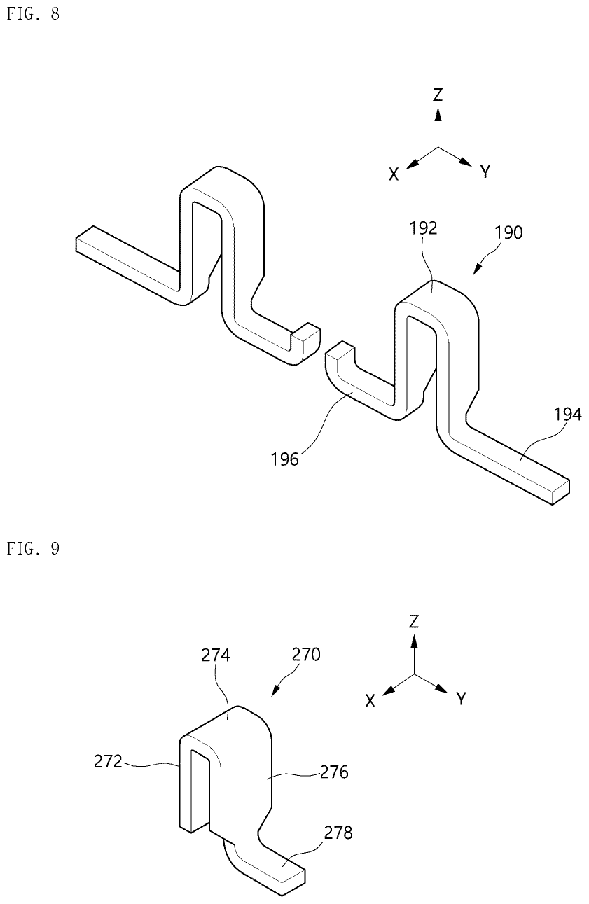

A receptacle ground contact 190 is disposed between the receptacle signal contact 170 and the receptacle RF contact 180 as shown in FIGS. 3, 8, and 14, and may be formed to be bent to be exposed along the surface of the receptacle socket 110.

Meanwhile, since the receptacle ground contact 190 is disposed between the receptacle RF contact 180 and the receptacle signal contact 170, the distance between the receptacle RF contact 180 and the receptacle signal contact 170 may be spaced apart as much as possible.

The receptacle ground contact 190 may include a receptacle ground contact part 192, a first receptacle ground shielding part 194, and a second receptacle ground shielding part 196.

The receptacle ground contact part 192 may be formed to be bent along the surface of the first receptacle socket wall 112 to contact the contact of the plug connector 200.

The first receptacle ground shielding part 194 may extend from the receptacle ground contact part 192 to one side in the Y direction.

The second receptacle ground shielding part 196 may extend from the receptacle ground contact part 192 to the other side in the Y direction opposite to the first receptacle ground shielding part 194. In this case, the second receptacle ground shielding part 196 may be fixed through the receptacle base 130.

Meanwhile, as shown in FIG. 2, said each receptacle ground contact 190 may be placed between the receptacle RF contact 180 and the receptacle signal contact 170 based on the X-axis direction. Accordingly, the receptacle ground contact 190 may be located between the first receptacle shield sidewall 151, the second receptacle shield sidewall 152, and the third receptacle shield sidewall 153 or between the first receptacle shield sidewall 151, the second receptacle shield sidewall 152, and the fourth receptacle shield sidewall 154 based on the X-axis direction.

Therefore, the receptacle connector 100 may form two first ground loops Cl surrounded by said each receptacle ground contact 190; and the first receptacle shield sidewall 151, the second receptacle shield sidewall 152, and the third receptacle shield sidewall 153; and the first receptacle shield sidewall 151, the second receptacle shield sidewall 152, and the fourth receptacle shield sidewall 154, thereby enhancing the shielding function for said each receptacle RF contact 180.

In addition, as shown in FIG. 2, the receptacle insulator 102 may include a receptacle soldering inspection window 104. The receptacle soldering inspection window 104 is formed through the receptacle insulator 102 and may be used to inspect a state in which the receptacle signal contact 170 is mounted on a substrate.

In this case, the receptacle signal mounting part 179 of the receptacle signal contact 170 may be coupled to be located in the receptacle soldering inspection window 104. Therefore, the receptacle signal mounting part 179 of the receptacle signal contact 170 is not covered by the receptacle insulator 102, so an operator may inspect the mounting state of the receptacle signal mounting part 179 through the receptacle soldering inspection window 104 while the receptacle connector 100 is mounted on the substrate.

Of course, the receptacle soldering inspection window may be formed not only around the receptacle signal contact 170 but also around the receptacle RF contact 180 and may also be used to inspect the mounting state of the receptacle RF contact 180.

FIG. 4 is a view illustrating a plug connector 200 according to the present embodiment. In the following description, for convenience of description, it may have a length in the X-axis direction, a width in the Y-axis direction, and a height in the Z-axis direction with respect to the drawing.

The plug connector 200 may include a plug insulator 202, a plug shield 250, and a plug contact 260.

The plug insulator 202 forms the outer shape of the plug connector 200 and is combined with other components of the plug connector 200 to support it. The plug insulator 202 may be formed of an electrically insulating material such as plastic, so that arbitrary current flow between components coupled to the plug insulator 202 may be prevented.

The plug insulator 202 is coupled to the plug shield 250, and the plug insulator 202 is partially surrounded by the plug shield 250.

The plug contact 260 is coupled to the plug insulator 202. The plug contact 260 may be provided in plurality, and the plurality of plug contacts 260 may be spaced apart from each other to be coupled to the plug insulator 202. The plug insulator 202 may support the plurality of plug contacts 260.

The plug insulator 202 may include a plug socket 210, a plug base 230, and a plug shield support part 240.

The plug base 230 forms the bottom surface of the plug insulator 202, and the plug socket 210 is formed to protrude upward from the plug base 230.

In this case, an island accommodation part 218 into which the receptacle island 120 of the receptacle insulator 102 is inserted may be formed at a central portion of the plug socket 210.

That is, the receptacle island 120 of the receptacle connector 100 may be inserted into the island accommodation part 218 of the plug connector 200 so that the receptacle connector 100 and the plug connector 200 may be electrically connected.

That is, the plug socket 210 may be formed to continuously protrude around the island accommodation part 218.

The plug socket 210 may include a pair of first plug socket walls 212 disposed to face each other and a second plug socket wall 214 formed between the first plug socket walls 212 and connecting the pair of first plug socket walls 212 to each other.

In addition, the second plug socket wall 214 may be formed to have a shorter length than the first plug socket wall 212.

The first plug socket wall 212 may be disposed along the X direction, and the second plug socket wall 214 may be disposed along the Y direction.

In addition, a terminal mount 216 may be formed on both outer sides of the second plug socket wall 214, respectively. The terminal mount 216 extends a predetermined length to be parallel to the first plug socket wall 212 and may protrude to the same height as the first plug socket wall 212.

A plug shield support part 240 for coupling with the plug shield 250 may be formed outside the plug socket 210.

The plug shield support part 240 may be formed to extend from each corner part of the plug socket 210.

That is, the plug base 230 at the corner where the first plug socket wall 212 and the second plug socket wall 214 of the plug socket 210 cross each other extends outward, and the plug shield support part 240 is formed to protrude from the plug socket 210 at a position where the plug base 230 extends outward.

In this case, the plug shield support part 240 at each corner may be formed continuously with each other, or may be formed separately so as not to be continuously connected.

As described above, the plug shield support part 240 may be coupled to the plug shield 250. In addition, the plug shield 250 coupled to the plug shield support part 240 and the plug socket 210 may form a receptacle accommodation part 244 in which the plug connector 200 and the receptacle connector 100 are physically coupled by inserting a part of the receptacle connector 100.

That is, the receptacle socket 110 of the receptacle connector 100 is inserted into the receptacle accommodation part 244, so that the plug connector 200 and the receptacle connector 100 are physically coupled.

Meanwhile, the plug shield 250 may be coupled to the plug insulator 202 to reinforce the rigidity of the plug insulator 202. In addition, the plug shield 250 may be coupled to the substrate (not shown) while being coupled to the plug insulator 202, thereby increasing the coupling force between the plug connector 200 and the substrate (not shown).

The plug shield 250 may be inserted into the second plug accommodation space 134 of the receptacle connector 100 when the plug connector 200 and the receptacle connector 100 are coupled.

In addition, the plug shield 250 may be energized by being in contact with the receptacle shield 150 of the receptacle connector 100.

That is, as the plug shield 250 is inserted into the second plug accommodation space 134 of the receptacle connector 100, the outer surface of the plug shield 250 and the inner surface of the receptacle shield 150 may be in contact with each other to be energized.

The plug shield 250 may be formed of an electrically conductive material for energization. In addition, the plug shield 250 may be formed of a highly rigid material. In the above embodiment, while the plug shield 250 is energized with the receptacle connector 100, the rigidity of the plug insulator 202 and the coupling force between the plug connector 200 and the substrate (not shown) may be increased at the same time.

The plug shield 250 may be formed by bending according to the shape of the edge of the plug insulator 202, and as shown in FIG. 4, it may be integrally formed along the shape of the plug shield support part 240 of the plug insulator 202 to cover it. The receptacle shield part may be formed by a deep drawing method, a die casting, a metal injection molding (MIM) method, a computer numerical control (CNC) machining, a machining center tool (MCT) machining, or bending and molding a plate material. The plug shield 250 may integrally cover the outer surface, and upper surface of the plug shield support part 240 without a joint or a disconnected area. The plug shield 250 may be made of a metal material such as copper (Cu) or an alloy including the same, and may perform a function of guiding the receptacle connector 100 when coupled to the receptacle connector 100.

That is, since the plug shield 250 is formed through a deep drawing method, the corners of the inner surface or outer surface of the plug shield 250 may be inclined gently. Therefore, when the receptacle connector 100 is coupled, the receptacle connector 100 may be naturally guided on the surface of the plug shield 250.

In addition, since the plug insulator 202 is made of a material of relatively weak strength such as plastic, there is a risk of damage due to impact applied when the receptacle connector 100 is coupled, and to prevent such damage, a metal plug shield 250 may be assembled to surround an edge of the plug insulator 202.

The side surface of the plug shield 250 may include a first plug shield sidewall 251 and a second plug shield sidewall 252 that extend in the X direction, a third plug shield sidewall 253 and a fourth plug shield sidewall 254 that extend in the Y direction. The first plug shield sidewall 251 and the second plug shield sidewall 252 may be spaced apart from each other in the Y direction and formed parallel to each other, and the third plug shield sidewall 253 and the fourth plug shield sidewall 254 may be spaced apart from each other in the X direction and formed parallel to each other.

In addition, a coupling protrusion 257 may be formed on a side surface of the plug shield 250. And, the coupling protrusion 257 may be inserted into the inner surface of the receptacle shield 150 in contact with the outer surface of the plug shield 250 to form a coupling groove 156.

Therefore, when the plug connector 200 and the receptacle connector 100 are coupled, the coupling protrusion 257 is inserted into the coupling groove 156 to fix them and increase the coupling force.

In the present embodiment, it is described as an example that the coupling protrusion 257 is formed in the plug shield 250, and the coupling groove 156 is formed in the receptacle shield 150, but the present disclosure is not necessarily limited thereto.

For example, a coupling groove 156 may be formed on the outer surface of the plug shield 250, and a coupling protrusion 257 may be formed on the outer surface of the receptacle shield 150. Alternatively, the coupling protrusion 257 may be formed to be engaged or occluded on the outer surface of the plug shield 250 and the outer surface of the receptacle shield 150.

In addition, electromagnetic interference emitted from the plug contact and the receptacle contact may be shielded by the coupling protrusion 257 and the coupling groove 156 being in close contact with each other.

It is important how much RF signal transmission transmitted by the plug connector 200 prevents communication quality from deteriorating, such as signal loss, unlike general signals. EMI shielding is important because leaking RF signals can cause malfunctions between electronic devices'chips, and it is important to shield RF signals from leaking to the outside because external noise entering RF contact causes signal loss and signal error. Furthermore, the greater the area in contact with the counterpart receptacle shield 150 to which the plug shield 250 is coupled, the better the RF signal shielding performance, so it is important to secure a contact area between the receptacle shield 150 and the plug shield 250 and ground them.

Meanwhile, a side surface of the plug shield 250 may include the first plug shield sidewall 251 to the fourth plug shield sidewall 254.

In addition, a coupling protrusion 257 may be formed on the first plug shield sidewall 251 to the fourth plug shield sidewall 254 as described above. The coupling protrusion 257 may be formed over a longitudinal direction in which the first plug shield sidewall 251 to the fourth plug shield sidewall 254 extend.

As described above, when the plug connector 200 and the receptacle connector 100 are coupled, the plug shield 250 may be inserted into the second plug accommodation space 134 of the receptacle connector 100.

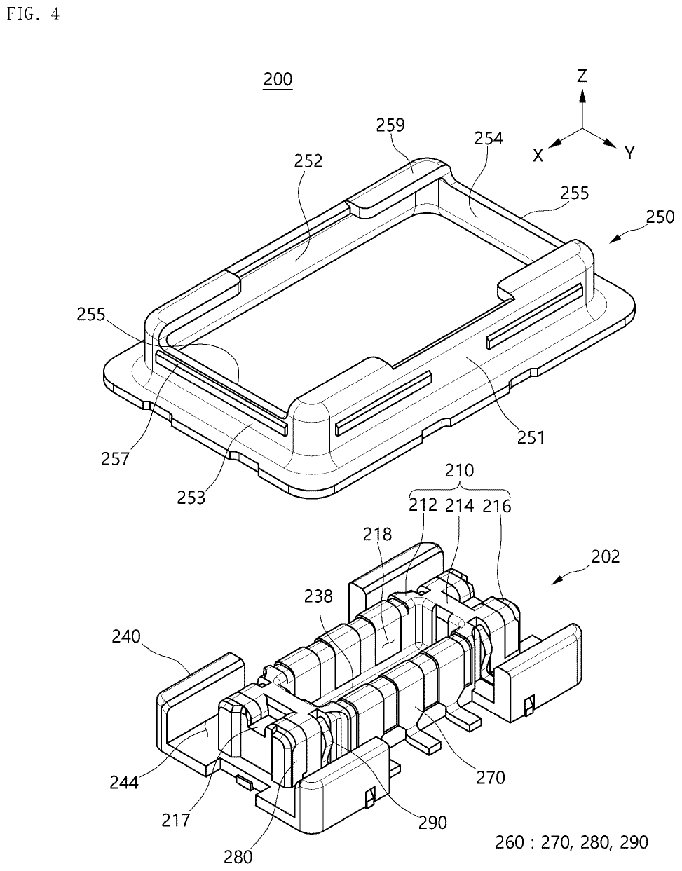

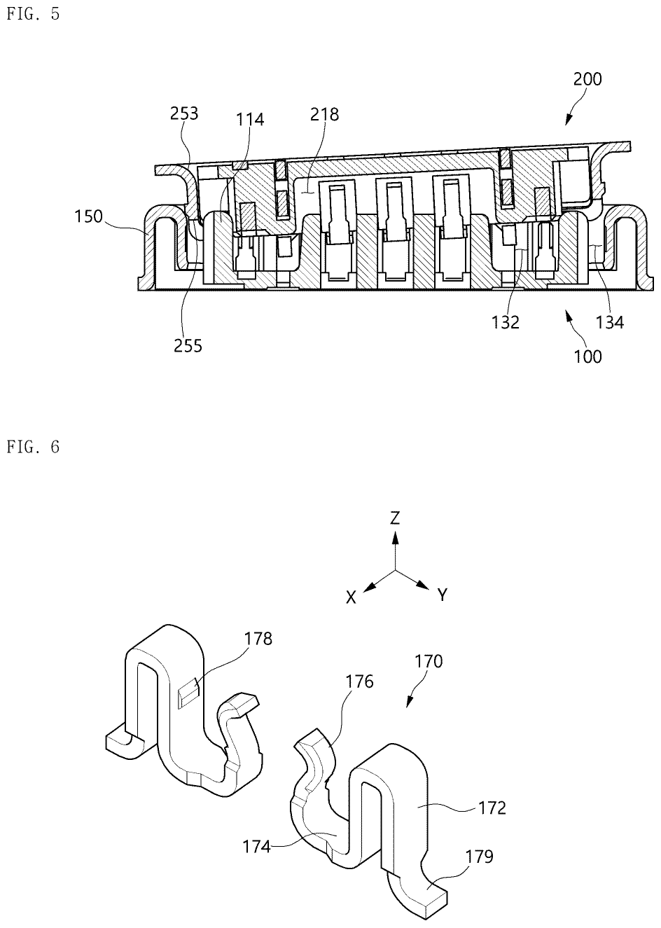

In this case, the outer surface of the plug shield 250 contacts the inner surface of the receptacle shield 150, and as shown in FIG. 5, if an inclination such as a slight twist in an angle occurs while the plug connector 200 is coupled to the receptacle connector 100, the second plug shield sidewall 253 of the plug shield 250 may contact the receptacle socket 110.

The plug shield 250 is made of a hard metal material while the receptacle socket 110 is made of a relatively soft plastic material, so if the plug shield 250 and the receptacle socket 110 are repeatedly in contact or excessive force is applied during the coupling process, there is a risk that the receptacle socket 110, which is formed of a relatively soft material, is damaged.

Therefore, recessed portions 255 may be formed where portions, corresponding to the receptacle socket 110, of the third plug shield sidewall 253 and the fourth plug shield sidewall 254 are formed to have a height lower than those of the remaining portions of the third plug shield sidewall 253 and the fourth plug shield sidewall 254 or those of the first plug shield sidewall 251 and the second plug shield sidewall 252.

That is, by forming the recessed portion 255 on the third plug shield sidewall 253 and the fourth plug shield sidewall 254, the third plug shield sidewall 253 and the fourth plug shield sidewall 254 of the plug shield 250 may be prevented from being in contact with the receptacle socket 110 while the plug connector 200 and the receptacle connector 100 are coupled, thereby preventing the receptacle socket 110 from being damaged.

The receptacle connector 100 or the plug connector 200 is a micro-sized product with a width of 1 cm or less and a length of 1 cm or less, and so it is impossible for an operator to visually check and work when fastening, which can cause many defects during fastening. Therefore, when designing such a micro-sized connector, product damage can be minimized only when designing such a micro-sized connector in consideration of these fine parts.

The height of the portion where the recessed portion 255 of the third plug shield sidewall 253 is formed may be 20 to 40% lower than the height of the remaining portion of the third plug shield sidewall 253 where the recessed portion 255 is not formed or the height of the first plug shield sidewall 251. Preferably, it may be formed at a 30% lower height.

In addition, the width of the recessed portion 255 may be formed to be equal to or wider than the width of the receptacle socket 110 in the width direction.

In addition, the upper end of the portion where the recessed portion 255 of the third plug shield sidewall 253 is formed may be formed at a location where the coupling protrusion 257 of the third plug shield sidewall 253 is formed.

Meanwhile, the plug connector 200 may include a probe contact part 259.

The probe contact part 259 is formed to have a flat plane on the upper surface of the plug shield 250, so that a space in which a probe of an inspection device can be contacted during an energization inspection can be secured.

Since the size of the connector 10 is ultra-small, and a probe of an inspection device that inspects the connector 10 is also ultra-small, a separate space must be secured for the small probe to contact the plug shield 250, and the probe contact part 259 can secure a space for the probe of the inspection device to contact.

The probe contact part 259 may be formed to extend a certain distance in the direction of the first plug shield sidewall 251 from an edge point where the first plug shield sidewall 251 and the third plug shield sidewall 253 meet each other.

In this case, when the probe member 200 and the receptacle connector 100 are coupled, the probe contact part 259 is accommodated in the second plug accommodation space 134, so that the length of the probe contact part 259 in the Y direction may be shorter than the length of the width in the second plug accommodation space 134 (a distance between the inner surface of the receptacle shield 150 and the outer surface of the receptacle socket 110).

Meanwhile, a plug contact 260 may be disposed on the plug insulator 202.

The plug contact 260 may electrically contact and be energized with the receptacle contact 160 when the receptacle connector 100 and the plug connector 200 are coupled to each other.

A plurality of the plug contacts 260 may be disposed in the plug socket 210 of the plug insulator 202 and may be coupled to the plug insulator 202 in an insert molding manner.

Some areas of the plug contact pin 260 may be exposed from the plug insulator 202 for contact with the substrate, and other areas of the plug contact pin may be exposed from the plug insulator 202 for electrical contact with the plug connector 200.

he plug contact 260 may be formed of an electrically conductive material. In addition, the plug contact 260 may be formed of a material having a predetermined elasticity. In an embodiment, the plug contact 260 may be formed of a metal material such as copper or an alloy including the same.

The plug contact pin 260 may include a plug signal contact 270, a plug RF contact 280, and a plug ground contact 290.

The plug signal contact 270 contacts the receptacle signal contact 170 and is electrically connected to the same when the plug connector 200 and the receptacle connector 100 are coupled, and a plurality of plug signal contacts 270 may be arranged at a constant pitch on the first plug socket wall 212 of the plug socket 210.

As shown in FIGS. 4, 9, and 12, the plug signal contact 270 may be formed to be bent to surround the outer surface, the upper surface, and the inner surface of the first plug socket wall 212.

The plug signal contact 270 may include a plug receptacle signal contact part 272 that is supported by being in close contact with the inner surface of the first plug socket wall 212 toward the island accommodation part 218, a plug signal support part 274 that is bent from the plug receptacle signal contact part 272 and supported by being in close contact with the upper surface of the first plug socket wall 212, and a plug signal connection part 276 that is bent from the plug signal support part 274 and faces the outer surface of the first plug socket wall 212.

In addition, a plug signal mounting part 278 extending in the Y direction from the plug signal connection part 276 may be formed. The plug signal mounting part 278 may be a part exposed to the outside of the plug insulator 202 and mounted on a substrate or the like.

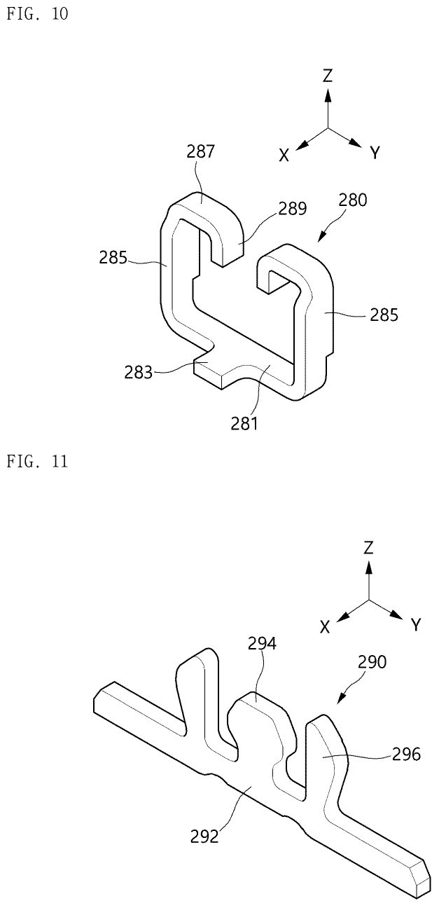

The plug RF contact 280 may contact the receptacle RF contact 180 and be electrically connected to the same when the plug connector 200 and the receptacle connector 100 are coupled, as shown in FIGS. 4, 10, and 13, and may be disposed on the both terminal mounts 216, respectively.

The plug RF contact 280 may include a plug RF embedded part 281 embedded in the plus socket or the plug base 230, a plug receptacle RF contact part 285 bent from the plug RF embedded part 281 toward the inner side of the plug connector 200 to be exposed along both outer surfaces of the terminal mount 216, a plug RF bent part 287 bent from the plug receptacle RF contact part 285 to be exposed along the upper surface of the terminal mount 216, and a plug RF coupling part 289 bent downward from the plug RF bent part 287 and to be coupled to the terminal mount 216.

A groove 219 is formed in the central part of the upper surface of the part where the plug RF contact 280 of the terminal mount 216 is disposed to form side surfaces facing each other on both sides of the groove 219, and the plug RF coupling part 289 may be disposed to be in close contact with and fixed to the side surfaces formed by the groove 219 of the terminal mount 216.

In addition, the plug RF contact 280 may extend from the plug RF embedded part 281 to the side surface of the plug base 230 to surround the side surface of the plug base 230 to form a plug RF fixing part 283 stably fixed to the plug base 230.

The plug RF fixing part 283 is formed to protrude from the plug RF embedded part 281 in a direction opposite to the direction in which the plug RF contact part 285 is formed. Since the plug RF fixing part 283 protrudes in the opposite direction to the plug RF contact part 285, contact starts from the top of the plug RF contact part 285 when coupled to the receptacle connector 100, and it may serve as a support part capable of holding the plug RF contact part 285 without collapsing even when an excessive force is applied.

The plug ground contact 290 contacts the receptacle ground contact 190 and is electrically connected to the same when the plug connector 200 and the receptacle connector 100 are coupled, and may be disposed between the plug signal contact 270 and the plug RF contact 280 of the both side second plug socket walls 214, respectively.

Meanwhile, since the plug ground contact 290 is disposed between the plug RF contact 280 and the plug signal contact 270, the distance between the plug RF contact 280 and the plug signal contact 270 may be spaced apart as much as possible so that the RF signal does not affect the plug signal contact 270. In addition, plug RF contacts 280 may be placed at both ends of the connector so that signal interference between the plug RF contacts 280 may be shielded as much as possible by allowing the plug RF contacts 280 to be spaced apart from each other as much as possible.

As shown in FIGS. 4, 11, and 14, the plug ground contact 290 may include a plug ground base member 292 disposed to cross the plug insulator 202, a plug ground fitting part 294 protruding upward from the central portion of the plug ground base member 292, and a plug ground curved contact part 296 protruding upward from the plug ground fitting part 294 and between the ends of the plug ground fitting part 294 and the plug ground base member 292 to be supported on the side surface of the second plug socket wall 214.

In this case, the plug ground fitting part 294 is fitted into the second plug socket wall 214, and a ground pin fixing groove 217 to which the plug ground fitting part 294 is inserted and fixed may be formed on the lower surface of the second plug socket wall 214 on which the plug ground contact 290 is placed.

That is, the plug ground fitting part 294 may be inserted into the ground pin fixing groove 217 to fix the plug ground contact 290.

In this case, both side surfaces of the plug ground fitting part 294 are formed to protrude, and both protruding side surfaces of the plug ground fitting part 294 may be forcibly fitted and fixed to the inner surface of the ground pin fixing groove 217.

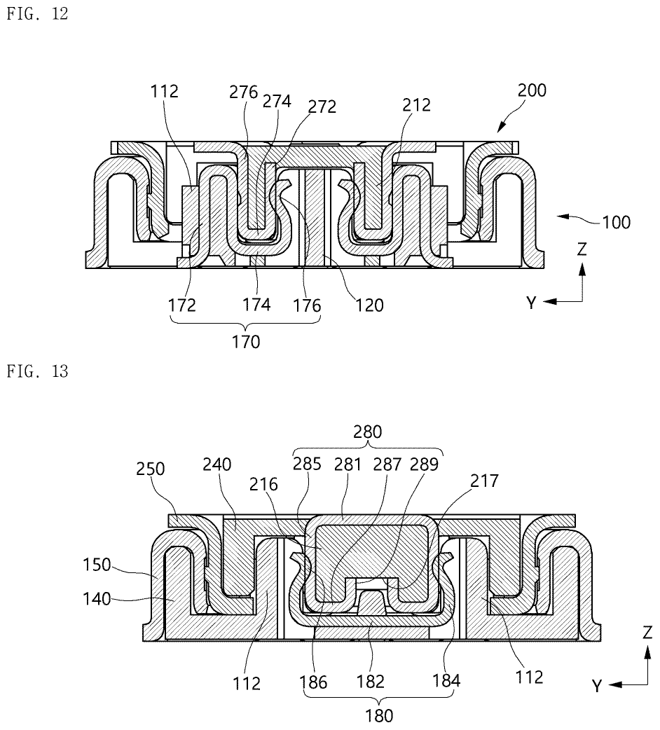

In addition, the side surface of the plug ground curved contact part 296 supported by the side surface of the second plug socket wall 214 is formed to correspond to the shape of the side surface of the second plug socket wall 214, and a surface of the plug ground curved contact part 296 facing the side surface of the second plug socket wall 214 may be curved to be convex toward the outside. FIGS. 12 to 14 are views illustrating a state in which the plug connector 200 and the receptacle connector 100 are coupled to each other.

As shown in FIGS. 5 and 12, when the plug connector 200 and the receptacle connector 100 are coupled, the plug socket 210 of the plug connector 200 and the receptacle socket 110 of the receptacle connector 100 are coupled while facing each other, so that the plug socket 210 is accommodated in the first plug accommodation space 132, and the plug shield 250 is accommodated in the second plug accommodation space 134. In addition, the receptacle island 120 is accommodated in the island accommodation part 218 of the plug socket 210.

Meanwhile, as the plug connector 200 and the receptacle connector 100 are coupled, the receptacle signal contact 170 and the plug signal contact 270 may be coupled, as shown in FIG. 12. In this case, the plug signal connection part 276 and the plug receptacle signal contact part 272 of the plug signal contact 270 may contact the receptacle signal contact part 176 and the pressing protrusion 178 of the receptacle signal contact 170 to make electrical contact. In addition, the contact between the receptacle signal contact 170 and the plug signal contact 270 may be maintained stably by the elasticity of the receptacle signal elastic part 174.

In addition, as the plug connector 200 and the receptacle connector 100 are coupled, the plug RF contact 280 and the receptacle RF contact 180 may be coupled, as shown in FIG. 13. In this case, as the plug RF contact 280 is introduced between the receptacle RF contact parts 186 of the receptacle RF contact 180, both side plug receptacle RF contact parts 285 of the plug RF contact 280 are in contact with both side receptacle RF contact parts 186 of the receptacle RF contact 180, respectively, and the contact between the receptacle RF contact part 186 of the receptacle RF contact 180 and the plug receptacle RF contact part 285 of the plug RF contact 280 may be stably maintained by the elasticity of the receptacle RF elastic part 184.

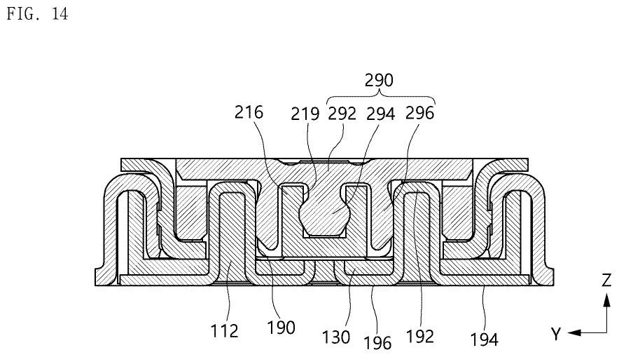

In addition, as the plug connector 200 and the receptacle connector 100 are coupled, the plug ground contact 290 and the receptacle ground contact 190 may be coupled, as shown in FIG. 14. That is, the plug ground curved contact part 296 of the plug ground contact 290 may be in contact with the side surface of the receptacle ground contact 190 to maintain the contact.

Meanwhile, as shown in FIG. 2, said each plug ground contact 290 may be placed between the plug RF contact 280 and the plug signal contact 270 based on the X-axis direction. Accordingly, the plug ground contact 290 may be located between the first plug shield sidewall 251, the second plug shield sidewall 252, and the third plug shield sidewall 253 or between the first plug shield sidewall 251, the second plug shield sidewall 252, and the fourth plug shield sidewall 254 based on the X-axis direction.

Therefore, the plug connector 200 may form two second ground loops C2 surrounded by said each plug ground contact 290; and the first plug shield sidewall 251, the second plug shield sidewall 252, and the third plug shield sidewall 253; and the first plug shield sidewall 251, the second plug shield sidewall 252, and the fourth plug shield sidewall 254, thereby enhancing the shielding function for said each plug RF contact 280.

In addition, as shown in FIG. 2, the plug insulator 202 may include a plug soldering inspection window 204. The plug soldering inspection window 204 is formed through the plug insulator 202 and may be used to inspect a state in which the plug signal contact 270 is mounted on a substrate.

In this case, the plug signal mounting part 278 of the plug signal contact 270 may be coupled to be located in the plug soldering inspection window 204. Therefore, the plug signal mounting part 278 of the plug signal contact 270 is not covered by the plug insulator 202, so an operator may inspect the mounting state of the plug signal mounting part 278 through the plug soldering inspection window 204 while the plug connector 200 is mounted on the substrate.

Of course, the plug soldering inspection window may be formed not only around the plug signal contact 270 but also around the plug RF contact 280 and may also be used to inspect the mounting state of the plug RF contact 280.

1. A connector, comprising:
a plug connector and a receptacle connector coupled to and electrically connected to the plug connector,
wherein the plug connector comprises:
a plug insulator having a length in a first direction and a width in a second direction orthogonal to the first direction;
a plurality of plug contacts coupled to the plug insulator and disposed to be spaced apart from each other along the first direction; and
a plug shield coupled to the plug insulator while covering an edge of the plug insulator,
wherein the plug shield comprises:
a first plug shield sidewall and a second plug shield sidewall forming a side surface in the first direction; and
a third plug shield sidewall and a fourth plug shield sidewall forming a side surface in the second direction,
wherein at least a portion of the third plug shield sidewall and the fourth plug shield sidewall is lower in height than the first plug shield sidewall or the second plug shield sidewall.

2. The connector of claim 1,
wherein the receptacle connector comprises:
a receptacle insulator having a length in the first direction and a width in the second direction orthogonal to the first direction;
a plurality of receptacle contacts coupled to the receptacle insulator and in electrical contact with the plurality of plug contacts; and
a receptacle shield coupled to the receptacle insulator while covering an edge of the receptacle insulator,
wherein the receptacle insulator comprises:
a receptacle socket comprising a pair of first receptacle socket walls placed along the first direction and placed apart from each other in the second direction, and a pair of second receptacle socket walls placed along the second direction, placed apart from each other in the first direction, and formed to be continuously connected to the first receptacle socket walls; and
a receptacle island configured to protrude from an inner surface of the receptacle socket in an internal space surrounded by the receptacle socket and to have a length in the first direction and a width in the second direction orthogonal to the first direction, and
wherein a first plug accommodation space is formed between the first receptacle socket wall, the second receptacle socket wall, and the receptacle island.

3. The connector of claim 2, wherein a recessed portion formed so that the height of the third plug shield sidewall and the fourth plug shield sidewall facing the second receptacle socket wall is lower than that of the first plug shield sidewall when the plug connector and the receptacle connector are coupled.

4. The connector of claim 3, wherein the width of the recessed portion is greater than or equal to that of the second receptacle socket wall.

5. The connector of claim 1, wherein the third plug shield sidewall and the fourth plug shield sidewall have a height that is 20 to 40% lower than the first plug shield sidewall and the second plug shield sidewall.

6. The connector of claim 1,
wherein a plug socket formed in the plug insulator, wherein the plug socket comprises:
a pair of first plug socket walls placed along the first direction and spaced apart from each other in the second direction;
a pair of second plug socket walls placed along the second direction, spaced apart from each other in the first direction, and formed to be continuously connected to the first plug socket walls; and
a terminal mount configured to extend a predetermined length to be parallel to the first plug socket wall outside each of the second plug socket walls, protrude to the same height as the first plug socket wall and have a groove in the central portion,
wherein an island accommodation part is formed in the plug socket, and
wherein the receptacle island is accommodated in the inside surrounded by the first plug socket wall and the second plug socket wall when the receptacle connector and the plug connector are coupled.

7. The connector of claim 6,
wherein the plug contact comprises:
a plurality of plug signal contacts disposed on the first plug socket wall;
a plug RF contact disposed on said each terminal mount; and
a plug ground contact disposed between the plug signal contact and the plug RF contact.

8. The connector of claim 2,
wherein the receptacle contact comprises:
a plurality of receptacle signal contacts that are disposed across from the first receptacle socket wall to the side surface of the receptacle island facing the first receptacle socket wall, and are disposed at regular intervals in the first direction;
a receptacle RF contact disposed on both ends of the first plug accommodation space and
a receptacle ground contact disposed between the receptacle signal contact and the receptacle RF contact of the first receptacle socket wall.

9. The connector of claim 8,
wherein the receptacle signal contact comprises:
a receptacle signal fixing part, at least a portion of the receptacle signal fixing part being embedded and fixed in the receptacle socket;
a receptacle signal elastic part configured to be bent along a surface extending from the receptacle signal fixing part toward the first plug accommodation space of the first receptacle socket wall and a surface of the receptacle island facing the first receptacle socket wall;
a receptacle signal contact part formed to be bent at the end of the receptacle signal elastic part to protrude toward the first plug accommodation space; and
a receptacle signal mounting part configured to extend outward from the receptacle signal fixing part and be mounted on a substrate.

10. The connector of claim 8,
wherein the receptacle RF contact comprises:
a receptacle RF base member disposed in the second direction of the receptacle socket;
a receptacle RF elastic part configured to be bent and extend upward from both ends of the receptacle RF base member; and
a receptacle RF contact part formed to be bent so that an end of the receptacle RF elastic part protrudes toward the central portion of the receptacle RF base member.

11. The connector of claim 7,
wherein the plug ground contact comprises:
a plug ground foundation member disposed to cross the plug insulator;
a plug ground fitting part configured to protrude upward from the central portion of the base member; and
a plug ground curved contact part configured to protrude upward from between the plug ground fitting part and an end of the plug ground base member, and be exposed to a side surface of the second plug socket wall.

12. The connector of claim 2,
wherein a portion of the plug insulator is opened to expose the state in which the plug contact is mounted on the substrate to form a plug soldering inspection window, and
wherein a portion of the receptacle insulator is opened to expose the state in which the receptacle contact is mounted on the substrate to form a receptacle soldering inspection window.

13. The connector of claim 1, further comprising at least one probe contact part configured to form a flat surface on the upper side of the plug shield so that a probe of an inspection device is in contact with the probe contact part.
